(19) United States
(12) Patent Application Publication
(10) Pub. No.: US 2015/0213520 A1
(43) Pub. Date: Jul. 30, 2015

(54) SYSTEMS AND METHODS PROVIDING ASSET CONFORMATION AND/OR VALUATION FOR A CUSTOMER MAKING A PURCHASE

(71) Applicant: MasterCard International Incorporated, Purchase, NY (US)

(72) Inventor: Bejoy Mathew, Dardenne Prairie, MO (US)

(73) Assignee: MasterCard International Incorporated, Purchase, NY (US)

(21) Appl. No.: 14/166,115

(22) Filed: Jan. 28, 2014

(51) Int. Cl. G06Q 30/02

(52) U.S. Cl. CPC G06Q 30/0278; G06Q 40/025

(57) ABSTRACT

According to some embodiments, an asset confirmation platform may receive transaction information about a purchase being made by a customer from a merchant. Responsive to the received transaction information, the asset confirmation platform may automatically determine a monetary value of at least one asset owned by the customer. The asset might be associated with, for example, stocks owned by the customer in a trading account. An indication associated with the monetary value of the asset may then be transmitted.

### BACKGROUND

A customer thinking about making a purchase from a merchant will typically consider his or her current cash “on hand” (e.g., in various saving and checking accounts) and an amount of credit that is readily available (e.g., via an existing credit card or home equity line of credit) when deciding whether or not the purchase is affordable. If the cost of the transaction is greater than, or even constitutes a substantially large portion of, his or her overall cash and available credit amounts, the customer may be unlikely to complete the transaction. For example, a customer who is considering purchasing a painting from an art gallery may have $50,000 in his or her bank account and a $15,000 limit on his or her credit card. If the price of the painting is $150,000, the customer will be unlikely to complete the purchase.

Moreover, the merchant may be hesitant to arrange for additional credit to be extended to such a customer due to the risks involved, especially when the cost of the transaction is relatively large as compared to that customer's overall cash and available credit amounts. For example, a jeweler might not be interested in providing additional credit to a customer to facilitate a purchase of a $50,000 necklace if the customer only has $10,000 in his or her bank account and a $5,000 limit on a credit card. Even if the merchant does decide to arrange for additional credit, the interest rate required by the additional risks involved may be substantial.

As a result, systems and methods to facilitate consideration of assets other than a customer's current cash and available credit amounts may be desired.

### BRIEF DESCRIPTION OF THE DRAWINGS

FIG. 1 is a block diagram overview of a system according to some embodiments of the present invention.

FIG. 2 illustrates a method that might be performed in accordance with some embodiments.

FIG. 3 is a high level overview of a system in accordance with some embodiments.

FIG. 4 illustrates a more detailed method that might be performed in accordance with some embodiments.

FIGS. 5A and 5B are asset confirmation registration displays that might be provided according to some embodiments.

FIG. 6 illustrates a registration method that might be performed in accordance with some embodiments.

FIG. 7 is a block diagram overview of another system according to some embodiments of the present invention.

FIG. 8 is block diagram of an asset confirmation platform according to some embodiments of the present invention.

FIG. 9 is a tabular portion of a registration database according to some embodiments.

FIG. 10 is a tabular portion of a transaction database in accordance with some embodiments.

FIG. 11 illustrates a shopping cart display on a handheld device according to some embodiments.

### DETAILED DESCRIPTION

A customer thinking about making a purchase from a merchant will typically consider his or her current cash “on hand” (e.g., in various saving, checking, and money market accounts) and an amount of credit that is readily available (e.g., via an existing credit card or home equity line of credit) when deciding whether or not the purchase is affordable. If the cost of the transaction is greater than, or even constitutes a substantially large portion of, his or her overall cash and available credit amounts, the customer may be unlikely to complete the transaction. Moreover, the merchant may be hesitant to arrange for additional credit to be extended to the customer due to the risks involved, especially when the cost of the transaction is large as compared to that customer's overall cash and available credit amounts. Even if the merchant does decide to arrange for additional credit, the interest rate required by the additional risk may be prohibitive.

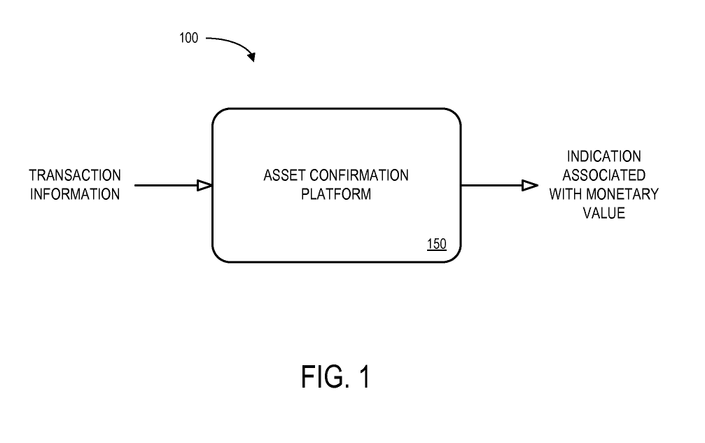

It would therefore be desirable to provide accurate, efficient systems and methods to facilitate consideration of assets other than a customer's current cash and available credit amounts. FIG. 1 is block diagram of a system 100 according to some embodiments of the present invention. In particular, the system 100 includes an asset confirmation platform 150 that receives information about a transaction. The transaction may be associated with, for example, a customer who is considering making a purchase from a merchant. The transaction information may be received, according to some embodiments, directly from a remote merchant device or via a credit card network.

The asset confirmation platform 150 may operate in any of the ways described herein and output an indication associated with a current monetary value of an asset owned by the customer, such as by outputting the information directly to a remote merchant device or via a credit card network.

The asset confirmation platform 150 might be associated with, for example, a Personal Computer (PC), laptop computer, an enterprise server, a server farm, and/or a database or similar storage devices. The asset confirmation platform 150 may, according to some embodiments, be associated with a credit card company. According to some embodiments, an “automated” asset confirmation platform 150 facilitates the determination of asset information. For example, the asset confirmation platform 150 may automatically respond to requests received from a number of different merchants (including online merchants). As used herein, the term “automated” may refer to, for example, actions that can be performed with little (or no) human intervention.

As used herein, devices, including those associated with the asset confirmation platform 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Although a single asset confirmation platform 150 is shown in FIG. 1, any number of such devices may be included. Moreover, various devices described herein might be combined according to embodiments of the present invention. For example, in some embodiments, the asset confirmation platform 150 and a business rules and logic database might be co-located and/or may comprise a single apparatus.

In accordance with some embodiments, the systems and methods described herein provide a framework to expand a customer's payment ecosystem beyond his or her current cash on hand and available credit. For example, a payment card may presented by a cardholder (e.g., the account owner) to make a payment to a merchant. By way of example, and without limiting the generality of the foregoing, a payment card can be a credit card, debit card, charge card, stored-value card, or prepaid card or nearly any other type of financial transaction card. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction” can be associated with, for example, a merchant, a merchant terminal, an automated teller machine (ATM), or any other suitable institution or device configured to initiate a financial transaction per the request of the account owner.

The information exchanged with the asset confirmation platform may be associated with, for example, a “payment card processing system” or “credit card processing networks”, such as the MasterCard® network that allows account owners to use payment cards issued by a variety of issuers to shop at a variety of merchants. With this type of payment card, a card issuer or attribute provider, such as a bank, extends credit to an account owner to purchase products or services. When an account owner makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the account owner's signature is also verified, a personal identification number is required or other user authentication mechanisms are imposed. The account owner is required to repay the bank for the purchases, generally on a monthly basis.

In accordance with some embodiments, the transaction data received by the asset confirmation platform may include, for example, a sales amount for a payment card transaction including the type of goods and/or services sold, a total number of goods and/or services sold in the transaction, a total sales amount for the transaction (e.g., gross dollar amount). In addition, depending on the merchant and/or business, the data associated with the transaction may include a point-of-sale or point-of-purchase (e.g., location of each payment card transaction). The point-of-sale or point-of-purchase provides that, for merchants and/or businesses having one or more locations, the location of the merchant and/or business that generated the sale can be identified.

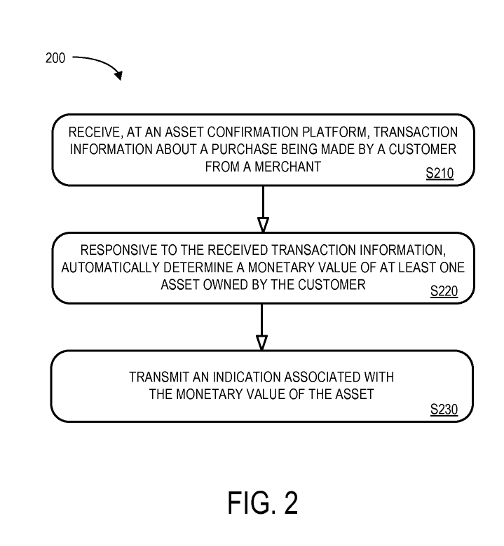

FIG. 2 illustrates a method 200 that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, transaction information associated with a purchase being made by a customer from a merchant may be received by an asset confirmation platform. The transaction information might be associated with a payment account such as, for example, a credit card account, a debit card account, a bank account, a pre-paid card account, or any other type of payment account. The transaction information may include, for example, an account identifier, a merchant identifier, a date, a time of day, a payment amount, a payment description, or any other type of transaction information. Note that the transaction information might be received via a credit card network or be received directly from a remote merchant device. According to some embodiments, the transaction information is associated with an online purchase, such as a purchase being made via an electronic shopping cart associated with the merchant and/or an electronic wallet account.

Responsive to the received transaction information, at S220 a monetary value of at least one asset owned by the customer may be automatically determined. For example, the customer's asset might be stocks owned by the customer. In this case, the determination at S220 may involve exchanging information with a trading account platform associated with the customer or a consolidated system database that has aggregated information associated with the net worth of the customer. According to other embodiments, the customer's asset might include bonds, a retirement account, a business, a vehicle, and/or real estate (e.g., the value of his or her house). Note that according to some embodiments, the confirmation platform may automatically confirm that the customer owns a particular asset (e.g., that the customer owns 10,000 shares of a particular stock).

At S230, an indication associated with the monetary value of the asset may be transmitted. For example, the asset confirmation platform might transmit the indication via a credit card network or directly to a remote merchant device. The transmitted indication might represent, for example, the monetary value (e.g., the customer owns $200,000 worth of stock) and/or an indication that the monetary value satisfied at least one pre-determined business rule (e.g., he or she owns stock worth at least 200% of the amount of the transaction being considered).

According to some embodiments, the asset confirmation platform does not arrange for an exchange of funds during the transaction approval period. Instead, a transaction agreement between the customer, the asset confirmation platform, and/or a stock trading account may be reached such that the customer will later sell a portion of his or her assets to complete payment. The asset confirmation system may generate revenue, for example, via a service fee, a per-transaction fee, and/or an interest fee on the money owed by the customer. Note that the more time the customer takes to settle the transaction, the more interest he or she might need to pay. According to other embodiments, the asset confirmation system and/or a trading account platform may automatically arrange for the customer's asset to be used as payment for the purchase (e.g., the trading account might automatically sell a number of stock shares and provide payment to the merchant).

In this way, a customer's purchasing power will not be limited to his or her available cash and credit amounts. Embodiments may provide customers with more funds and/or a bigger amount of credit—such as when they are interested in purchasing relatively expensive items. For example, a customer who has a $10,000 credit limit on his or her credit card might be interested in purchasing a $50,000 automobile. Because the car dealer can verify that the customer owns $100,000 work of stock in his or her trading account, the transaction may be enabled and the relatively high interest rates associated with a typical automobile loan may be avoided.

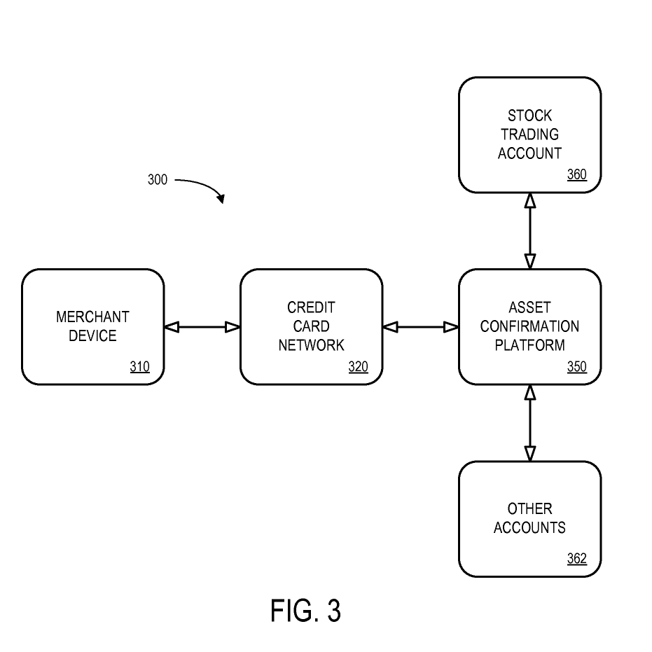

FIG. 3 is a high level overview of a system 300 in accordance with some embodiments. According to this embodiment, a merchant device 310 may transmit transaction information to an asset confirmation platform 350 via a credit card network 320. For example, a customer may have enabled an asset confirmation feature associated with his or her credit card. Note that such an asset confirmation feature might be offered as an added value aspect of a premium credit card. When the asset confirmation platform 350 receives the transaction information, it may exchange data with a stock trading account 360 to determine a current value of the customer's stock trading account. This information may then be transmitted back to the merchant device 310 via the credit card network 320. According to some embodiments, the asset confirmation platform 350 may exchange information with one or more other accounts 362, such as accounts associated with stock trading, money markets, retirement funds, college saving plans, etc. In this way, the asset confirmation platform 350 may aggregate information to determine an overall net worth associated with the customer.

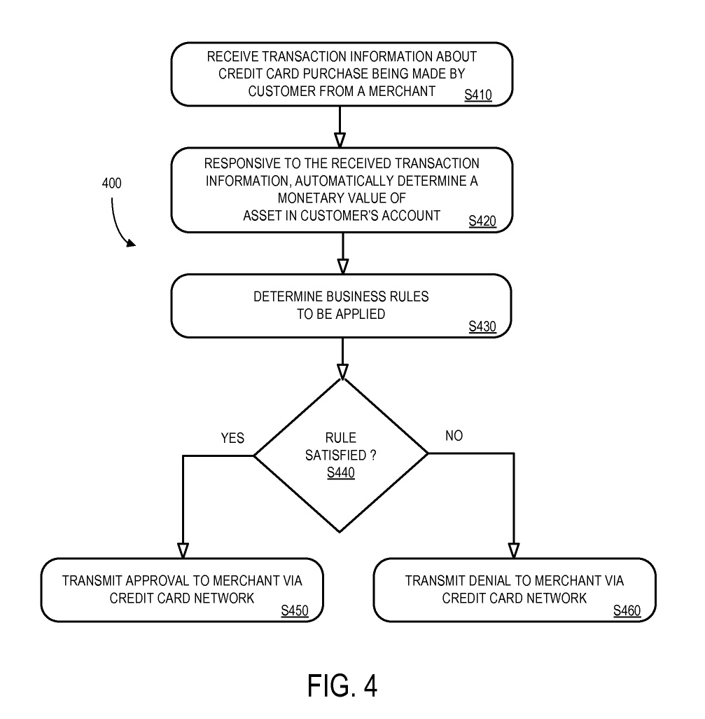

FIG. 4 illustrates a more detailed method 400 that might be performed in accordance with some embodiments. At S410, information about a credit card purchase being made by a customer from a merchant is received at an asset confirmation platform via a credit card network. Responsive to the received information, the asset confirmation platform automatically determines a monetary value of assets in the customer's account (or multiple accounts), such as the value of stocks in the customer's trading account. At S430, one or more business rules and/or logic to be applied to the transaction may be determined. Note that different rules or logic might be associated with different merchants, types of customers, types of transaction, types of stock trading accounts, etc. If the rule is satisfied at S440, an approval is transmitted to the merchant via the credit card network at S450. If the rule is not satisfied at S440, a denial is transmitted to the merchant via the credit card network at S460. The business rule or logic might comprise, for example, “are customer's total stock holdings worth at least three times the purchase price?” or “does the customer own at least $100,000 more than the purchase price?”

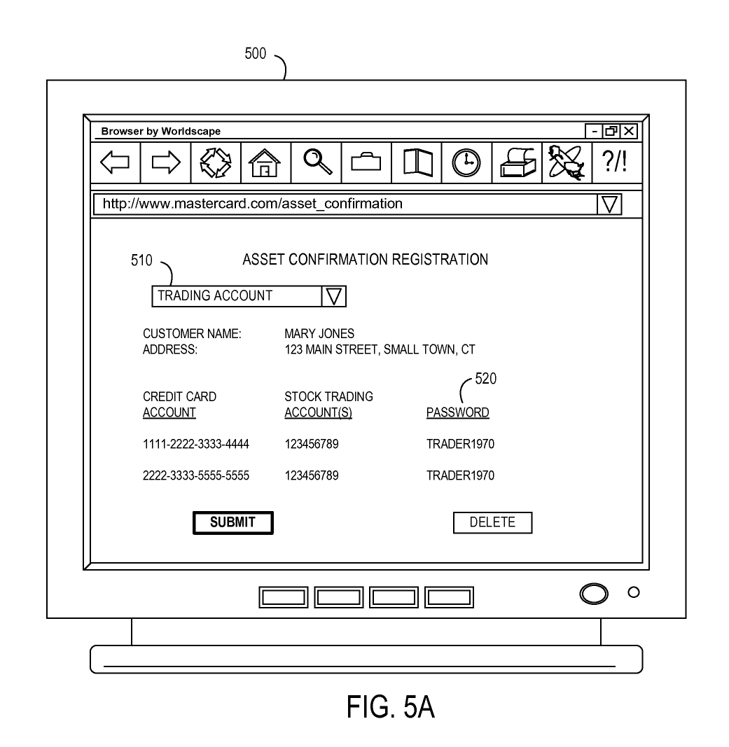

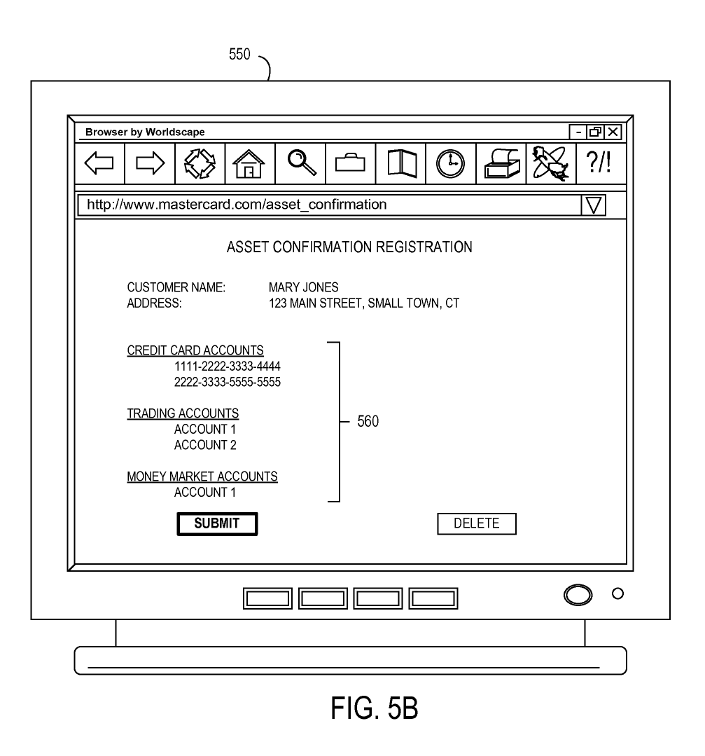

According to some embodiments, a customer may pre-register to use an asset confirmation service. FIG. 5A is an asset confirmation registration display 500 that might be provided according to some embodiments. The display 500 includes an account type selection 510 that the customer can use to indicate that his or her credit card should be linked to a stock trading account, retirement stock investments, etc. The customer can use a data entry area 520 on the display 500 to enter stock trading account identifiers, user names, passwords, etc. to identify his or her assets. FIG. 5B is another example of an asset confirmation registration display 550 that might be provide in accordance with some embodiments. In particular, the display 550 includes an interactive area 560 that a customer can use to add or delete various types of accounts associated with assets that have a financial value which will, in turn, increase or decrease his or her overall network of assets.

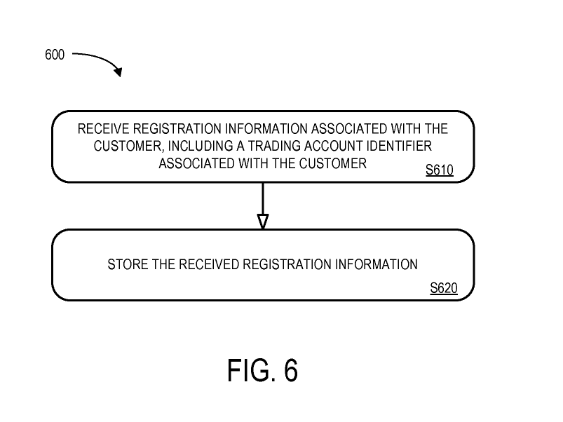

FIG. 6 illustrates a registration method 600 that might be performed in accordance with some embodiments. At S610, an asset confirmation platform may receive registration information associated with a customer, including a trading account identifier. At S620, this information may be stored by the asset confirmation platform for later use when the customer is making a purchase. The store information might be associated with, for example, the customer's credit card number or electronic or digital wallet.

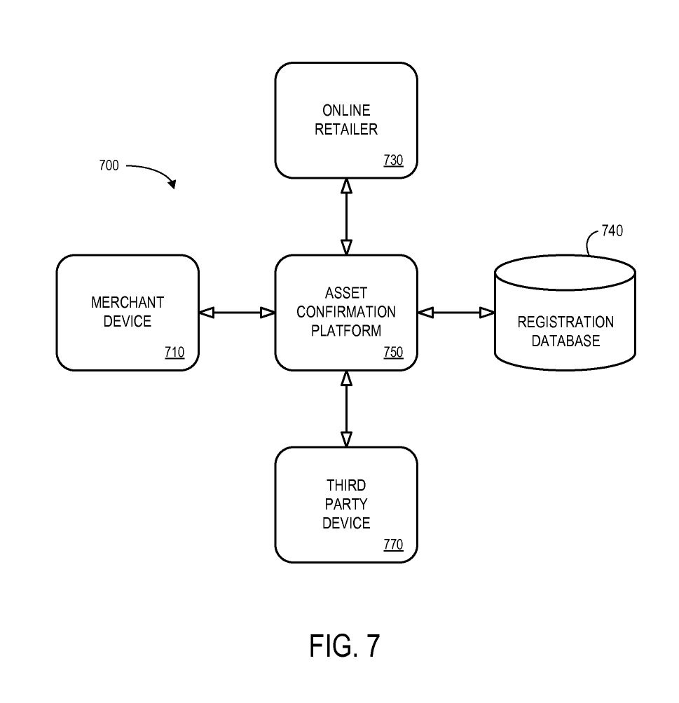

FIG. 7 is a block diagram overview of another system 700 according to some embodiments of the present invention. According to this embodiment, a merchant device 710 transmits transaction information directly to an asset confirmation platform 750, such as be using an Application Programming Interface (“API”). The asset confirmation platform may access a registration database 740 to identify the customer and exchange information with a third party device 770, such as a service that tracks and verifies different types of assets that are owned by the customer (e.g., stocks, bonds, real estate, etc.). The asset confirmation platform 750 can then transmit the appropriate result to the merchant device 710. According to some embodiments, the asset confirmation platform 750 performs a similar service for on online retailer 730 (e.g., via the customer's online shopping cart).

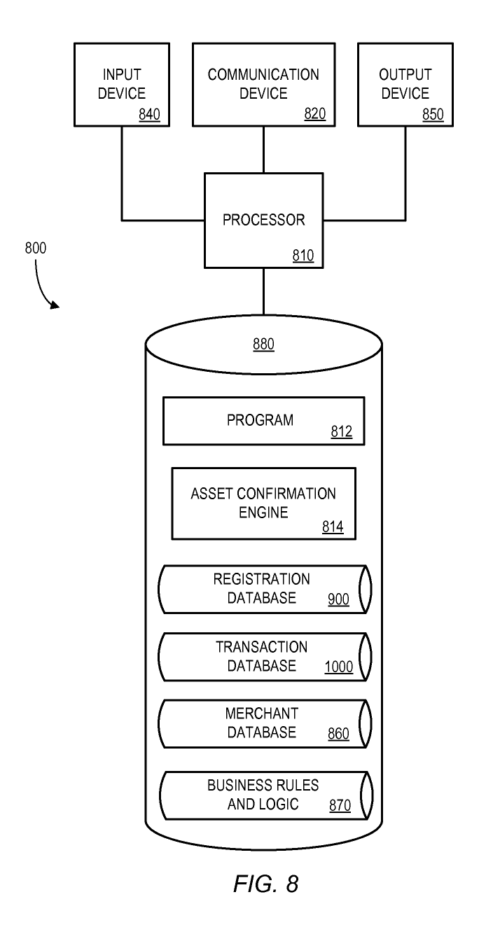

Note that the embodiments described herein may be implemented using any number of different hardware configurations. For example, FIG. 8 illustrates an asset confirmation platform 800 that may be, for example, associated with the systems 100, 300, 700 of FIGS. 1, 3, and 7. The asset confirmation platform 800 comprises a processor 810, such as one or more commercially available Central Processing Units (CPUs) in the form of one-chip microprocessors, coupled to a communication device 820 configured to communicate via a communication network (not shown in FIG. 8). The communication device 820 may be used to communicate, for example, with one or more transaction databases. The asset confirmation platform 800 further includes an input device 840 (e.g., a computer mouse and/or keyboard to enter information about business rules or logic) and an output device 850 (e.g., a computer monitor or printer to output a reports and/or support user interfaces).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 812 and/or asset confirmation platform logic 814 for controlling the processor 810. The processor 810 performs instructions of the programs 812, 814, and thereby operates in accordance with any of the embodiments described herein. For example, the processor 810 may receive transaction information about a purchase being made by a customer from a merchant. Responsive to the received transaction information, the processor 810 may automatically determine a monetary value of at least one asset owned by the customer. The asset might be associated with, for example, stocks owned by the customer in a trading account. An indication associated with the monetary value of the asset may then be transmitted by the processor 810.

The programs 812, 814 may be stored in a compressed, uncompiled and/or encrypted format. The programs 812, 814 may furthermore include other program elements, such as an operating system, a database management system, and/or device drivers used by the processor 810 to interface with peripheral devices.

As used herein, information may be “received” by or “transmitted” to, for example: (i) the asset confirmation platform 800 from another device; or (ii) a software application or module within the asset confirmation platform 800 from another software application, module, or any other source.

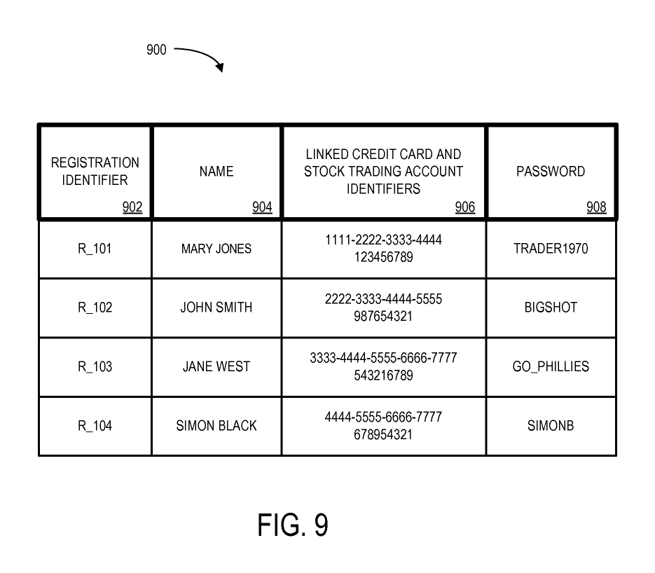

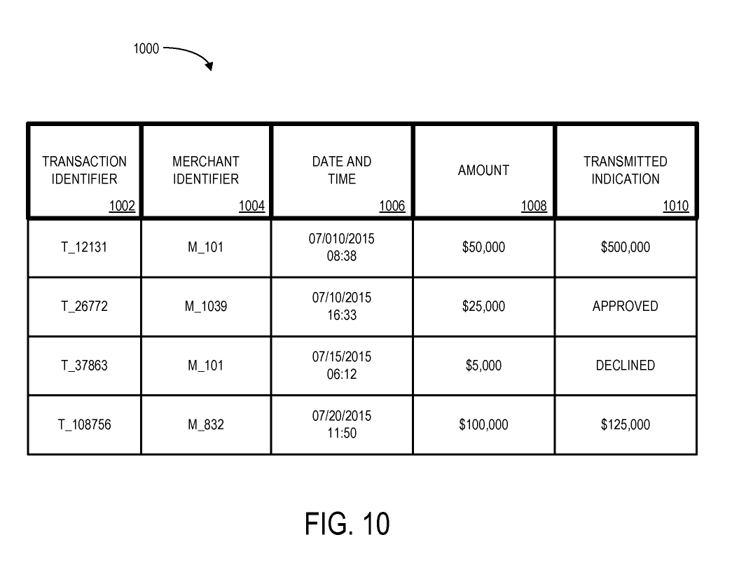

In some embodiments (such as shown in FIG. 8), the storage device 830 further stores a registration database 900, a transaction database 1000, a merchant database 860, and business rules and logic 870. Some examples of databases that may be used in connection with the asset confirmation platform 800 will now be described in detail with respect to FIGS. 9 and 10. Note that the databases described herein are only examples, and additional and/or different information may actually be stored therein. Moreover, various databases might be split or combined in accordance with any of the embodiments described herein. For example, the merchant database 860 and business rules and logic 870 might be combined and/or linked to each other within the asset confirmation platform 800.

Note that the merchant database 860 may store a “business classification,” which is a group of merchants and/or businesses, by the type of goods and/or service the merchant and/or business provides. For example, the group of merchants and/or businesses can include merchants and/or business, which provide similar goods and/or services. In addition, the merchants and/or businesses can be classified based on geographical location, sales, and any other type of classification, which can be used to associate a merchant and/or business with similar goods, services, locations, economic and/or business sector, industry and/or industry group.

Similarly, the merchant database 860 might store a Merchant Category Code (“MCC”) which is a four-digit number created by MasterCard® or VISA® and assigned to a business by the acquirer when the business first starts accepting one of these cards as a form of payment. The MCC is used to classify the business by the type of goods or services it provides. For example, in the United States, the merchant category code can be used to determine if a payment needs to be reported to the IRS for tax purposes. In addition, Merchant Category Codes (or “MCCs”) are used by card issuers to categorize, track or restrict certain types of purchases.

The business classification and/or MCC might be used to apply different business rules and logic 870 to transactions. For example, a transaction that was approved from an automobile dealership might not have been approved if it had been received from a casino.

Referring to FIG. 9, a table is shown that represents the registration database 900 that may be stored at the asset confirmation platform 800 according to some embodiments. The table may include, for example, entries identifying customers who have signed up to use an asset confirmation service. The table may also define fields 902, 904, 906, 908 for each of the entries. The fields 902, 904, 906, 908 may, according to some embodiments, specify: a registration identifier 902, a name 904, linked credit card and stock trading account identifiers 906, and a password. The registration database 900 may be updated, for example, as customers sign up to the use the asset confirmation service (e.g., by activating that feature for their credit cards).

The registration identifier 902 may be, for example, a unique alphanumeric code identifying an asset confirmation customer associated with the name 904. The linked credit card and stock trading account identifiers 906 may, for example, link the customer's credit card number with his or her stock trading account number. The customer's password 908 may, for example, let the asset confirmation platform “log into” the customer's trading account to determine the current value of his or her stock holdings.

Referring to FIG. 10, a table is shown that represents the transaction database 1000 that may be stored at the asset confirmation platform 800 according to some embodiments. The table may include, for example, entries identifying transactions that have been processed via a payment account (e.g., credit card transactions). The table may also define fields 1002, 1004, 1006, 1008, 1010 for each of the entries. The fields 1002, 1004, 1006, 1008, 1010 may, according to some embodiments, specify: a transaction identifier 1002, a merchant identifier 1004, a date and time 1006, an amount 1008, and a transmitted indication 1010. The transaction database 1000 may be created and updated, for example, as merchant devices, credit card network requests, and/or online electronic wallets are used to provide transaction information.

The transaction identifier 1002 may be associated with a particular transaction (e.g., a purchase at an auction house). According to some embodiments, an account identifier may also be stored, such as a unique alphanumeric code identifying a payment account or a Primary Account Number (“PAN”). The merchant identifier 1004 may indicate which merchant submitted the transaction information. The date and time 1006 may indicate when the transaction occurred, and the amount 1008 may indicate the total monetary amount of the transaction. The transmitted indication 1010 might comprise the actual monetary value of the customer's assets, a transaction approval or denial, etc.

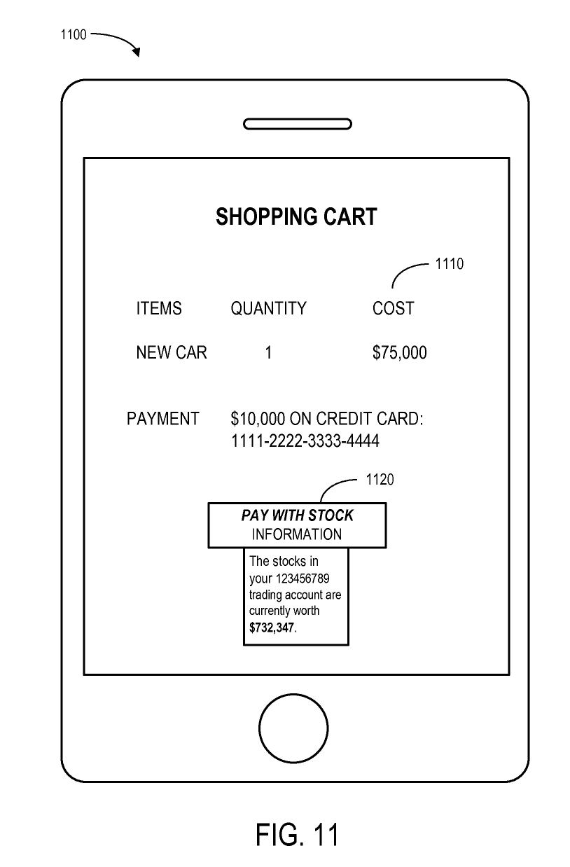

FIG. 11 illustrates a shopping cart display on a handheld device 1100 according to some embodiments. In this example, the customer's shopping cart 1110 includes a new automobile that costs $75,000. Moreover, an “asset confirmation area” 1120 of the display indicates that he or she owns stocks that are currently worth $732,347. As a result, the customer may be more likely to complete the purchase.

In this way, the customer's purchase power and willingness to pay will not be limited to his or her cash on hand (in savings and checking accounts) and the credit available on his or her credit card. Instead, other assets, such as stock may be leveraged as another currency to be considered when making purchases. According to some embodiments, a new payment ecosystem leverages stock as a currency for payment at the point of sale and/or in ecommerce shopping carts. Such an approach may bring the market value of the stocks carried by customers as currency/credit for payments. For example, a “pay with stock” option could be provided as a payment option for an online shopping cart or digital wallet. By expanding the overall pie of available funds, embodiments described herein may increase customer's purchasing power.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method, comprising:
receiving, at an asset confirmation platform, transaction information about a purchase being made by a customer from a merchant;
responsive to the received transaction information, automatically determining, by a computer processor of the asset confirmation platform, a monetary value of at least one asset owned by the customer; and
transmitting an indication associated with the monetary value of the asset.

2. The method of claim 1, wherein the at least one asset includes stocks owned by the customer and said determining includes exchanging information with a trading account platform associated with the customer.

3. The method of claim 2, further comprising, prior to said receiving:
receiving registration information associated with the customer, the registration information including a trading account identifier associated with the customer; and
storing the received registration information.

4. The method of claim 1, wherein the at least one asset includes at least one of: (i) bonds, (ii) a retirement account, (iii) a business, (iv) a vehicle, and (v) real estate.

5. The method of claim 1, wherein the transaction information is associated with a credit card network.

6. The method of claim 1, wherein the transaction information is associated with an online purchase.

7. The method of claim 6, wherein the online purchase is associated with at least one of: (i) an electronic shopping cart associated with the merchant, and (ii) an electronic wallet account.

8. The method of claim 1, wherein the transaction information is received directly from a merchant device.

9. The method of claim 1, further comprising:
automatically arranging for the at least one asset to be used as payment for the purchase.

10. The method of claim 1, wherein the transmitted indication comprises at least one of: (i) the monetary value, and (ii) an indication that the monetary value satisfied at least one pre-determined business rule.

11. A non-transitory, computer-readable medium having stored therein instructions that, upon execution, cause a computer processor to perform a method, the method comprising:
receiving, at an asset confirmation platform, transaction information about a purchase being made by a customer from a merchant;
responsive to the received transaction information, determining a monetary value of at least one asset owned by the customer; and
transmitting an indication associated with the monetary value of the asset.

12. The medium of claim 11, wherein the at least one asset includes stocks owned by the customer and said determining includes exchanging information with a trading account platform associated with the customer.

13. The medium of claim 12, wherein the method further comprises, prior to said receiving:
receiving registration information associated with the customer, the registration information including a trading account identifier associated with the customer; and
storing the received registration information.

14. The medium of claim 11, wherein the transaction information is associated with at least one of: (i) a credit card network, (ii) an online purchase, (iii) an electronic shopping cart associated with the merchant, and (iv) an electronic wallet account.

15. The medium of claim 11, wherein the transaction information is received directly from a merchant device.

16. The medium of claim 11, wherein the transmitted indication comprises at least one of: (i) the monetary value, and (ii) an indication that the monetary value satisfied at least one pre-determined business rule.

17. A system, comprising:
a communication port to receive transaction information about a purchase being made by a customer from a merchant; and
an asset confirmation platform to: (i) responsive to the received transaction information, automatically determine a monetary value of at least one asset owned by the customer, and (ii) transmit an indication associated with the monetary value of the asset.

18. The system of claim 17, wherein the at least one asset includes stocks owned by the customer and the asset confirmation platform exchanges information with a trading account platform associated with the customer.

19. The system of claim 18, wherein the asset confirmation platform is further to, prior to said receiving: (i) receive registration information associated with the customer, the registration information including a trading account identifier associated with the customer, and (ii) store the received registration information.

20. The system of claim 17, wherein the transaction information is associated with at least one of: (i) a credit card network, (ii) an online purchase, (iii) an electronic shopping cart associated with the merchant, and (iv) an electronic wallet account.
